(19) United States
(12) Patent Application Publication
(10) Pub. No.: US 2012/0074868 A1
(43) Pub. Date: Mar. 29, 2012

(54) DRIVING CIRCUIT FOR DRIVING LIGHT EMITTING DIODES AND SHORT CIRCUIT PROTECTION CIRCUIT APPLIED TO A DRIVING CIRCUIT FOR DRIVING LIGHT EMITTING DIODES

(76) Inventors: Yang-Tai Tseng, Hsinchu County (TW); Chih-Hsiung Hsu, Hsinchu County (TW)

(21) Appl. No.: 12/939,157

(22) Filed: Nov. 3, 2010

(30) Foreign Application Priority Data
Sep. 29, 2010 (TW) 099132994

(51) Int. Cl. H05B 37/02

(52) U.S. Cl. 315/294

(57) ABSTRACT

A short circuit protection circuit applied to a driving circuit of light emitting diodes is coupled to a highest-voltage detection circuit, a current balance circuit, and a voltage-feedback control circuit for generating a driving-current control signal and a voltage-feedback control signal according to the highest voltage of the highest-voltage detection circuit to disable the current balance circuit and the voltage-feedback control circuit so as to implement short lamp protection.

### BACKGROUND OF THE INVENTION

1. Field of the Invention

The present invention is related to a driving circuit for driving light emitting diodes, and particularly to a driving circuit for driving light emitting diodes with a short circuit protection circuit.

2. Description of the Prior Art

In the prior art, dimming methods of light emitting diodes (LEDs) have two modes, a burst mode and a continuous mode. In the burst mode, a driving circuit for driving light emitting diodes utilizes an alternating current voltage/direct current voltage (AC/DC) converting circuit to convert a pulse width modulation (PWM) dimming control signal to a corresponding direct current voltage, and controls turning-on and turning off of a driving current for driving light emitting diodes. The driving circuit can control luminance of light emitting diodes according to an average of the driving current.

In the prior art, the driving circuit for driving light emitting diodes only has an open circuit protection function, or only detects a driving voltage for driving light emitting diodes to prevent a current sink providing a driving current for the light emitting diodes from being burned out. But, the prior art does not provide a short circuit protection function when at least one of the light emitting diodes is short circuited.

### SUMMARY OF THE INVENTION

An embodiment of the present invention provides a driving circuit for driving light emitting diodes. The driving circuit includes an alternating current voltage/direct current voltage (AC/DC) converting circuit, a highest-voltage detection circuit, a current balance circuit, a voltage-feedback control circuit, and a short circuit protection circuit. The alternating current voltage/direct current voltage (AC/DC) converting circuit is used for converting a pulse width modulation (PWM) dimming control signal to a corresponding first direct current voltage. The highest-voltage detection circuit is used for detecting a highest voltage VH of voltages of first terminals of the plurality of series of light emitting diodes. The current balance circuit is used for sensing and controlling driving currents flowing through the plurality of series of light emitting diodes. The voltage-feedback control circuit is coupled to the alternating current voltage/direct current voltage converting circuit for receiving a voltage-feedback control signal to control the first direct current voltage. And the short circuit protection circuit is coupled to the highest-voltage detection circuit, the current balance circuit, and the voltage-feedback control circuit for generating a driving-current control signal and the voltage-feedback control signal according to the highest voltage to disable the current balance circuit and the voltage-feedback control circuit.

Another embodiment of the present invention provides a short circuit protection circuit applied to a driving circuit for driving light emitting diodes. The driving circuit includes an alternating current voltage/direct current voltage (AC/DC) converting circuit, a highest-voltage detection circuit, a current balance circuit, and a voltage-feedback control circuit. The short circuit protection circuit includes a comparator, a current control circuit, and a voltage control circuit. The comparator is used for comparing a highest voltage of the highest-voltage detection circuit with a reference voltage to generate a short circuit control signal. The current control circuit is used for generating a driving-current control signal according to the short circuit control signal. And the voltage control circuit is used for generating a voltage-feedback control signal according to the short circuit control signal.

The present invention provides a driving circuit for driving light emitting diodes and a short circuit protection circuit applied to a driving circuit for driving light emitting diodes. The driving circuit and the short circuit protection circuit utilize a highest-voltage detection circuit to detect a highest voltage. Then, a short circuit protection circuit generates a voltage-feedback control signal and a driving-current control signal to disable a voltage-feedback control circuit and a current balance circuit respectively according to the highest voltage. Therefore, the present invention can provide a short circuit protection function when at least one of the plurality of series of light emitting diodes is short circuited.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a driving circuit for driving light emitting diodes according to an embodiment of the present invention.

FIG. 2 is a diagram illustrating a driving circuit for driving light emitting diodes according to another embodiment of the present invention.

FIG. 3A is a diagram illustrating a driving circuit for driving light emitting diodes according to another embodiment of the present invention.

FIG. 3B is a diagram illustrating a driving circuit for driving light emitting diodes according to another embodiment of the present invention.

FIG. 4 is a diagram illustrating a short circuit protection circuit applied to a driving circuit or driving light emitting diodes according to another embodiment of the present invention.

FIG. 5 is a diagram illustrating a short circuit protection circuit applied to a driving circuit or driving light emitting diodes according to another embodiment of the present invention.

### DETAILED DESCRIPTION

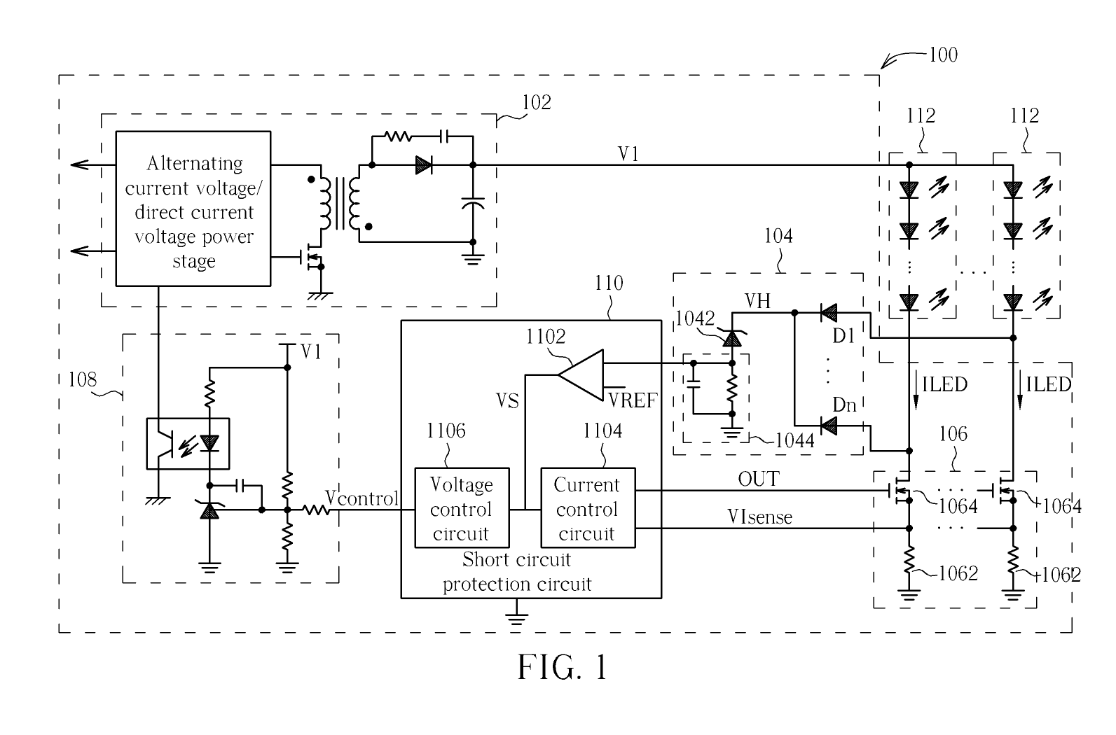

Please refer to FIG. 1. FIG. 1 is a diagram illustrating a driving circuit 100 for driving light emitting diodes according to an embodiment of the present invention. The driving circuit 100 includes an alternating current voltage/direct current voltage (AC/DC) converting circuit 102, a highest-voltage detection circuit 104, a current balance circuit 106, a voltage-feedback control circuit 108, and a short circuit protection circuit 110. The alternating current voltage/direct current voltage (AC/DC) converting circuit 102 is used for converting a pulse width modulation (PWM) dimming control signal to a corresponding first direct current voltage V1, where the first direct current voltage V1 is used for driving a plurality of series of light emitting diodes 112, and the first direct current voltage V1 is greater than a voltage drop of each series of light emitting diodes 112. For example, if a series of light emitting diodes 112 includes eight series light emitting diodes (a voltage drop of a light emitting diode is 3V), the first direct current voltage V1 must be greater than 24V. But, the present invention is not limited to the series of light emitting diodes 112 including eight series light emitting diodes. The highest-voltage detection circuit 104 is used for detecting a highest voltage VH of voltages of first terminals of the plurality of series of light emitting diodes 112, where the highest-voltage detection circuit 104 utilizes a plurality of parallel diodes D1-Dn coupled to the first terminals of the plurality of series of light emitting diodes 112 to detect the highest voltage VH. When at least one of the plurality of series of light emitting diodes 112 is short circuited, a zener diode 1042 of the highest-voltage detection circuit 104 passes the highest voltage VH to the short circuit protection circuit 110. In addition, a resistor-capacitor filter 1044 included by the highest-voltage detection circuit 104 is used for delaying the highest voltage VH traveling to the short circuit protection circuit 110. The current balance circuit 106 is used for sensing and controlling driving currents ILEDs flowing through the plurality of series of light emitting diodes 112. The voltage-feedback control circuit 108 is coupled to the alternating current voltage/direct current voltage converting circuit 102 for receiving a voltage-feedback control signal Vcontrol to control the first direct current voltage V1. The short circuit protection circuit 110 is coupled to the highest-voltage detection circuit 104, the current balance circuit 106, and the voltage-feedback control circuit 108 for generating a driving-current control signal OUT and the voltage-feedback control signal Vcontrol according to the highest voltage VH to disable the current balance circuit 106 and the voltage-feedback control circuit 108. In addition, the current balance circuit 106 includes a plurality of sensing resistors 1062 for converting the driving currents ILEDs flowing through the plurality of series of light emitting diodes 112 to corresponding voltages VIsenses and transmitting the corresponding voltages VIsenses to the short circuit protection circuit 110, and a plurality of switches 1064 for turning on and turning off the driving currents ILEDs flowing through the plurality of series of light emitting diodes 112 according to the driving-current control signal OUT of the short circuit protection circuit 110, where the plurality of switches 1064 are N-type metal-oxide-semiconductor transistors.

The short circuit protection circuit 110 includes a comparator 1102, a current control circuit 1104, and a voltage control circuit 1106. After the short circuit protection circuit 110 receives the highest voltage VH of the highest-voltage detection circuit 104, the comparator 1102 compares the highest voltage VH with a reference voltage VREF. If the highest voltage VH is greater than the reference voltage VREF, the comparator 1102 generates a short circuit control signal VS. The current control circuit 1104 is coupled to the comparator 1102 for turning off the driving-current control signal OUT transmitted to the current balance circuit 106 according to the short circuit control signal VS. The voltage control circuit 1106 is coupled to the comparator 1102 for turning off the voltage-feedback control signal Vcontrol transmitted to the voltage-feedback control circuit 108 according to the short circuit control signal VS.

Therefore, when at least one of the plurality of series of light emitting diodes 112 is short circuited, the current balance circuit 106 and the voltage-feedback control circuit 108 are turned off to protect the driving circuit 100.

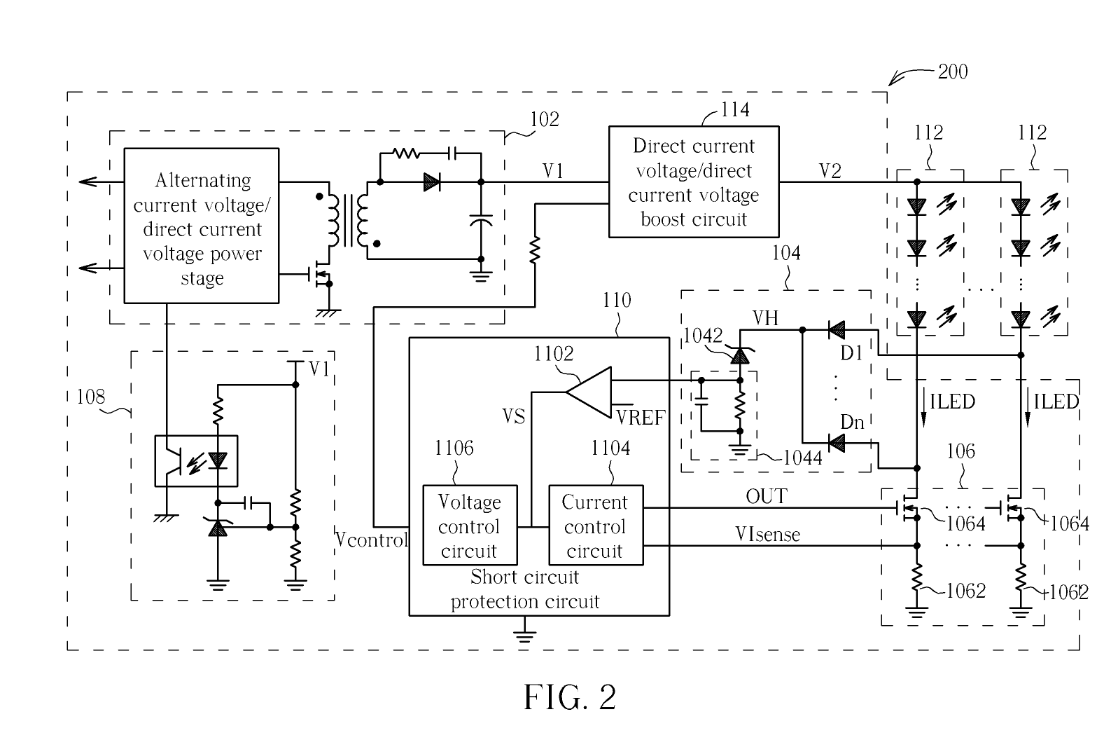

Please refer to FIG. 2. FIG. 2 is a diagram illustrating a driving circuit 200 for driving light emitting diodes according to another embodiment of the present invention. A difference between the driving circuit 200 and the driving circuit 100 is that the driving circuit 200 further includes a direct current voltage/direct current voltage (DC/DC) boost circuit 114 coupled between the alternating current voltage/direct current voltage converting circuit 102 and the plurality of series of light emitting diodes 112 for boosting the first direct current voltage V1 to a second direct current voltage V2, where the second direct current voltage V2 is used for driving the plurality of series of light emitting diodes 112 and the voltage-feedback control signal Vcontrol is used for turning on or turning off the direct current voltage/direct current voltage boost circuit 114. For example, the direct current voltage/direct current voltage boost circuit 114 boosts the first direct current voltage V1 (3V) to the second direct current voltage V2 (12V/24V). But, the present invention is not limited to the first direct current voltage V1 being 3V, and the second direct current voltage V2 being 12V/24V. Further, subsequent operational principles of the driving circuit 200 are the same as the driving circuit 100, so further description thereof is omitted for simplicity.

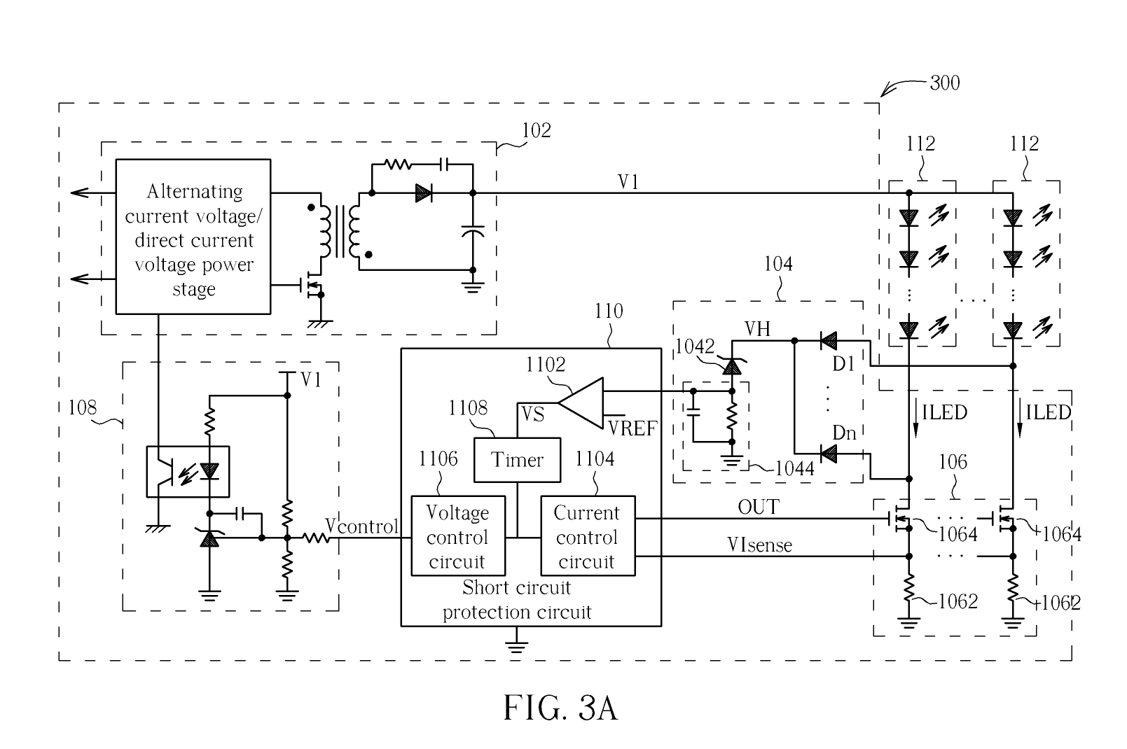

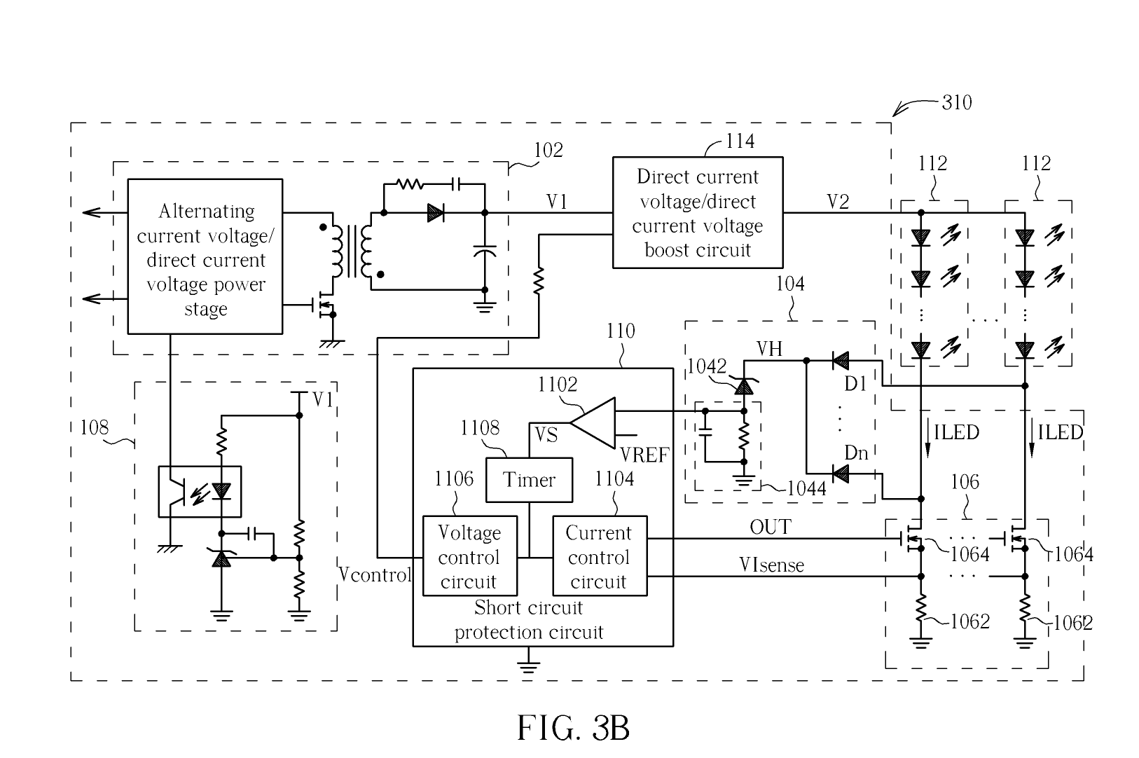

Please refer to FIG. 3A. FIG. 3A is a diagram illustrating a driving circuit 300 for driving light emitting diodes according to another embodiment of the present invention. A difference between the driving circuit 300 and the driving circuit 100 is that the short circuit protection circuit 110 further includes a timer 1108 coupled to an output terminal of the comparator 1102 for delaying the short circuit control signal VS by a predetermined time T1. Further, subsequent operational principles of the driving circuit 300 are the same as the driving circuit 100, so further description thereof is omitted for simplicity.

Please refer to FIG. 3B. FIG. 3B is a diagram illustrating a driving circuit 310 for driving light emitting diodes according to another embodiment of the present invention. A difference between the driving circuit 310 and the driving circuit 100 is that the driving circuit 310 further includes a direct current voltage/direct current voltage boost circuit 114 and a timer 1108, where the direct current voltage/direct current voltage boost circuit 114 is coupled between the alternating current voltage/direct current voltage converting circuit 102 and the plurality of series of light emitting diodes 112 for boosting the first direct current voltage V1 to a second direct current voltage V2, and the timer 1108 is coupled to the output terminal of the comparator 1102 for delaying the short circuit control signal VS by a predetermined time T1. Further, subsequent operational principles of the driving circuit 310 are the same as the driving circuit 100, so further description thereof is omitted for simplicity.

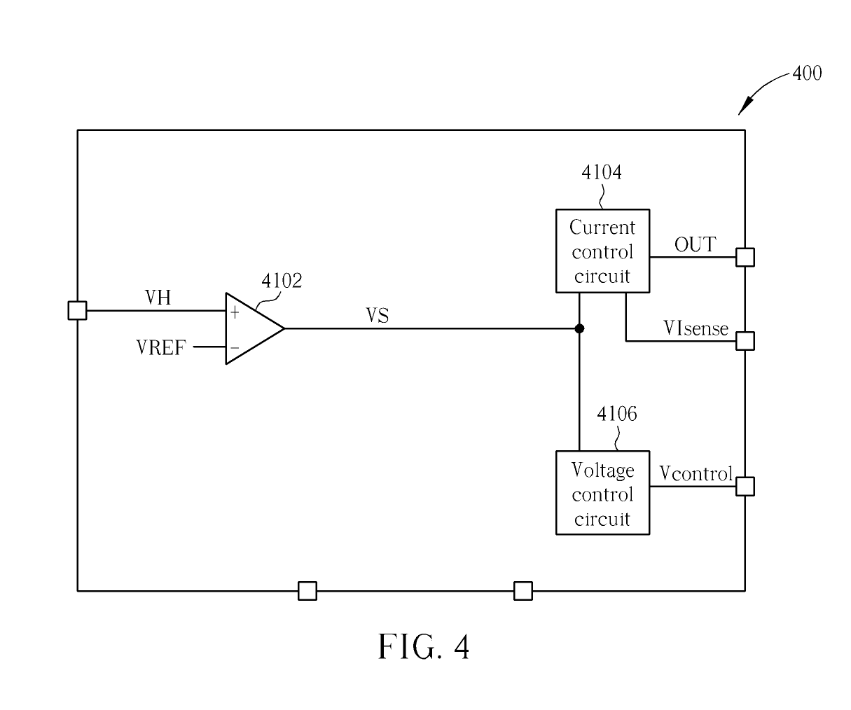

Please refer to FIG. 4. FIG. 4 is a diagram illustrating a short circuit protection circuit 400 applied to a driving circuit for driving light emitting diodes according to another embodiment of the present invention. The short circuit protection circuit 400 includes a comparator 4102, a current control circuit 4104, and a voltage control circuit 4106. After the short circuit protection circuit 400 receives the highest voltage VH of the highest-voltage detection circuit 104 of the driving circuit 100, the comparator 4102 compares the highest voltage VH with the reference voltage VREF. If the highest voltage VH is greater than the reference voltage VREF, the comparator 1102 generates a short circuit control signal VS. The current control circuit 4104 is coupled to the comparator 4102 for turning off the driving-current control signal OUT transmitted to the current balance circuit 106 of the driving circuit 100 according to the short circuit control signal VS. The voltage control circuit 4106 is coupled to the comparator 4102 for turning off the voltage-feedback control signal Vcontrol transmitted to the voltage-feedback control circuit 108 of the driving circuit 100 according to the short circuit control signal VS. In addition, the plurality of switches 1064 turn off the driving currents ILEDs of the plurality of series of light emitting diodes 112 when the current control circuit 4104 turns off the driving-current control signal OUT transmitted to the current balance circuit 106.

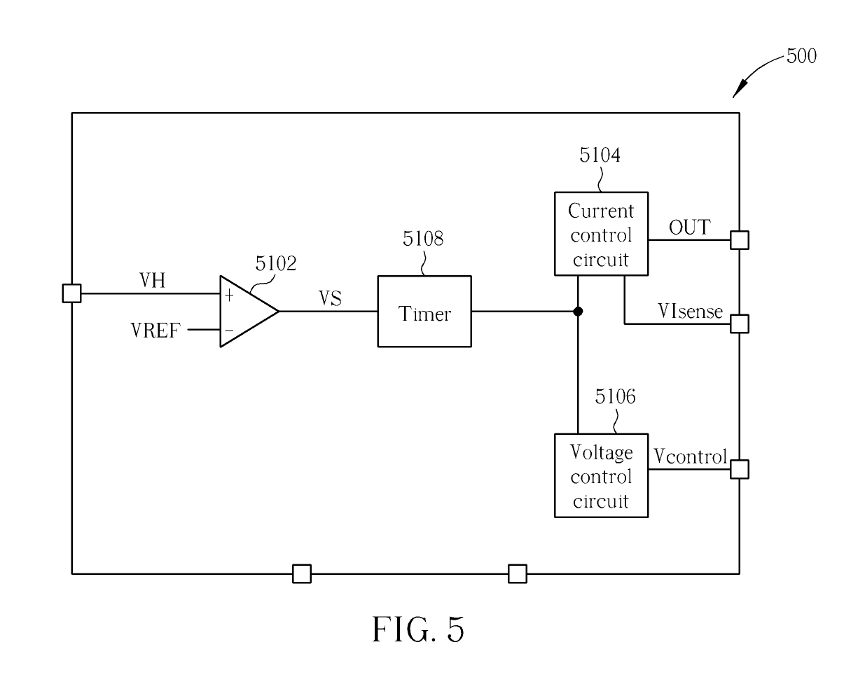

Please refer to FIG. 5. FIG. 5 is a diagram illustrating a short circuit protection circuit 500 applied to a driving circuit for driving light emitting diodes according to another embodiment of the present invention. A difference between the short circuit protection circuit 500 and the short circuit protection circuit 400 is that the short circuit protection circuit 500 further includes a timer 5108 coupled to the output terminal of the comparator 4102 for delaying the short circuit control signal VS by a predetermined time T1. Further, subsequent operational principles of the short circuit protection circuit 500 are the same as the short circuit protection circuit 400, so further description thereof is omitted for simplicity.

To sum up, the driving circuit for driving light emitting diodes and the short circuit protection circuit applied to the driving circuit for driving light emitting diodes utilize the highest-voltage detection circuit to detect the highest voltage, and the short circuit protection circuit to generate the voltage-feedback control signal and the driving-current control signal to disable the voltage-feedback control circuit and the current balance circuit, respectively, according to the highest voltage. Therefore, the present invention can provide a short circuit protection function when at least one of the plurality of series of light emitting diodes is short circuited.

Those skilled in the art will readily observe that numerous modifications and alterations of the device and method may be made while retaining the teachings of the invention.

What is claimed is:

1. A driving circuit for driving light emitting diodes, the driving circuit comprising:
an alternating current voltage/direct current voltage (AC/DC) converting circuit for converting a pulse width modulation (PWM) dimming control signal to a corresponding first direct current voltage;
a highest-voltage detection circuit for detecting a highest voltage of voltages of first terminals of a plurality of series of light emitting diodes;
a current balance circuit for sensing and controlling driving currents flowing through the plurality of series of light emitting diodes;
a voltage-feedback control circuit coupled to the alternating current voltage/direct current voltage converting circuit for receiving a voltage-feedback control signal to control the first direct current voltage; and
a short circuit protection circuit coupled to the highest-voltage detection circuit, the current balance circuit, and the voltage-feedback control circuit for generating a driving-current control signal and the voltage-feedback control signal according to the highest voltage to disable the current balance circuit and the voltage-feedback control circuit.

2. The driving circuit of claim 1, further comprising:
a direct current voltage/direct current voltage boost circuit for boosting the first direct current voltage to a second direct current voltage.

3. The driving circuit of claim 1, wherein the highest-voltage detection circuit comprises:
a plurality of parallel diodes coupled to the first terminals of the plurality of series of light emitting diodes for detecting the highest voltage; and
a resistor-capacitor filter for delaying the highest voltage traveling to the short circuit protection circuit.

4. The driving circuit of claim 1, wherein the current balance circuit comprises:
a plurality of sensing resistors for converting the driving currents flowing through the plurality of series of light emitting diodes to corresponding voltages and transmitting the corresponding voltages to the short circuit protection circuit; and
a plurality of switches for turning on and turning off the driving currents flowing through the plurality of series of light emitting diodes according to the driving-current control signal of the short circuit protection circuit.

5. The driving circuit of claim 4, wherein the plurality of switches are N-type metal-oxide-semiconductor transistors.

6. The driving circuit of claim 1, wherein the short circuit protection circuit comprises:
a comparator for comparing the highest voltage with a reference voltage to generate a short circuit control signal;
a current control circuit for generating the driving-current control signal according to the short circuit control signal; and
a voltage control circuit for generating the voltage-feedback control signal according to the short circuit control signal.

7. The driving circuit of claim 6, further comprising:
a timer coupled to an output terminal of the comparator for delaying the short circuit control signal by a predetermined time.

8. The driving circuit of claim 1, wherein the highest-voltage detection circuit further comprises:
a zener diode for passing the highest voltage to the short circuit protection circuit.

9. A short circuit protection circuit applied to a driving circuit for driving light emitting diodes, the driving circuit including an alternating current voltage/direct current voltage converting circuit, a highest-voltage detection circuit, a current balance circuit, and a voltage-feedback control circuit, the short circuit protection circuit comprising:
a comparator for comparing a highest voltage of the highest-voltage detection circuit with a reference voltage to generate a short circuit control signal;
a current control circuit for generating a driving-current control signal according to the short circuit control signal; and
a voltage control circuit for generating a voltage-feedback control signal according to the short circuit control signal.

10. The short circuit protection circuit of claim 9, further comprising:
a timer coupled to an output terminal of the comparator for delaying the short circuit control signal a predetermined time.

11. The short circuit protection circuit of claim 9, wherein the driving-current control signal is used for turning off a plurality of switches of the current balance circuit.

12. The short circuit protection circuit of claim 9, wherein the voltage-feedback control signal is used for decreasing a first direct current voltage controlled by the voltage-feedback control circuit.
